(19) United States
(12) Patent Application Publication
(10) Pub. No.: US 2026/0197550 A1
(43) Pub. Date: Jul. 9, 2026

(54) IMAGE CAPTURING APPARATUS, CONTROL METHOD, AND STORAGE MEDIUM FOR SELECTING IMAGE DISPLAY DESTINATION

(71) Applicant: CANON KABUSHIKI KAISHA, Tokyo (JP)

(72) Inventors: HIROMU KOSEKI, Kanagawa (JP); HIROKAZU IZUOKA, Kanagawa (JP)

(21) Appl. No.: 19/424,758

(22) Filed: Dec. 18, 2025

(30) Foreign Application Priority Data
Jan. 8, 2025 (JP) 2025-003074

(51) Int. Cl. H04N 23/63; H04N 23/53

(52) U.S. Cl. CPC H04N 23/632; H04N 23/531

(57) ABSTRACT

An image capturing apparatus has a first display unit and a second display unit. The first display unit is attached to a body of the image capturing apparatus in such a manner that a positional relationship of the first display unit with the body is changeable. The image capturing apparatus selects one of the first display unit and the second display unit as a display destination, and performs control to display an image on the selected display destination. The first display unit is selected in a case where a first selection condition is satisfied, and the second display unit is selected in a case where the first selection condition is not satisfied. The first selection condition is a condition that an object is not in proximity to the second display unit and furthermore the positional relationship satisfies a predetermined positional condition.

### BACKGROUND

### Field of the Technology

The present disclosure relates to an image capturing apparatus, a control method, and a storage medium for selecting an image display destination.

### Description of the Related Art

In some cases, a digital camera, which is an example of an image capturing apparatus, includes a plurality of display units (e.g., a vari-angle monitor outside a viewfinder, and an electronic viewfinder (EVF) inside the viewfinder).

Japanese Patent Laid-Open No. 2021-071572 discloses a technique to select an image display destination from among a plurality of display units in accordance with a selection criterion corresponding to a display destination setting that has been selected by a user. For example, in a case where the display destination setting is "auto 2", an EVF is selected when the user's eye is near the EVF, and a vari-angle monitor is selected when the user's eye is not near the EVF, regardless of whether the vari-angle monitor is at an open position or a closed position. Also, in a case where the display destination setting is "fixed to viewfinder", the EVF is selected regardless of whether the vari-angle monitor is at the open position or the closed position, and also regardless of whether the user's eye is near the EVF.

The "fixed to viewfinder" setting of Japanese Patent Laid-Open No. 2021-071572 is thought to be useful for a user who prefers to use the EVF. However, even for a user who prefers to use the EVF, there is a possibility that it is difficult to look through the EVF depending on the situation. For example, there are cases where, in order to shoot a subject near the user's feet, the user holds the camera at a so-called low position by lowering the camera to the position of the subject. In such cases, there is a possibility that the user has difficulty looking through the EVF. Similarly, also in cases where the user holds the camera at a so-called high position, there is a possibility that the user has difficulty looking through the EVF. Therefore, even in cases where the user prefers to use the EVF, it is not always true that unconditionally selecting the EVF as the display destination leads to improvements in the user experience.

### SUMMARY

The present disclosure provides, in at least some aspects thereof, a technique to make a selection that is intended to further improve the user experience in an image capturing apparatus that selects either a first display unit attached to the body of the image capturing apparatus in such a manner that its positional relationship with the body is changeable or a second display unit as a display destination.

According to one aspect of the present disclosure, there is provided an image capturing apparatus, comprising: a first display unit attached to a body of the image capturing apparatus in such a manner that a positional relationship of the first display unit with the body is changeable; a second display unit; and at least one processor and/or at least one circuit configured to: determine whether an object is in proximity to the second display unit; determine whether the positional relationship satisfies a predetermined positional condition; select one of the first display unit and the second display unit as a display destination, including selecting the first display unit in a case where a first selection condition is satisfied, and selecting the second display unit in a case where the first selection condition is not satisfied, wherein the first selection condition is a condition that the object is not in proximity to the second display unit and furthermore the positional relationship satisfies the predetermined positional condition; and perform control to display an image on the selected display destination.

Features of the present disclosure will become apparent from the following description of embodiments with reference to the attached drawings. The following description of embodiments is described by way of example.

### BRIEF DESCRIPTION OF THE DRAWINGS

FIG. 1A to 1C are external views of a digital camera 100

FIG. 2A is a top view of FIG. 1A.

FIG. 2B is a top view of FIG. 1C.

FIG. 3A is a side view of FIG. 1B.

FIG. 3B is a side view of FIG. 1C.

FIGS. 3C and 3D are side views of a vari-angle monitor 101a of FIG. 1B in a state where it has been turned by Θr degrees relative to a camera body 100a.

FIG. 4 is a block diagram showing an internal configuration of the digital camera 100.

FIG. 5A is a diagram showing an example of a display destination setting screen displayed by the digital camera 100.

FIG. 5B is a diagram showing display destination selection criteria corresponding to different display destination settings.

FIG. 6 is a flowchart of display destination selection processing executed by the digital camera 100.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

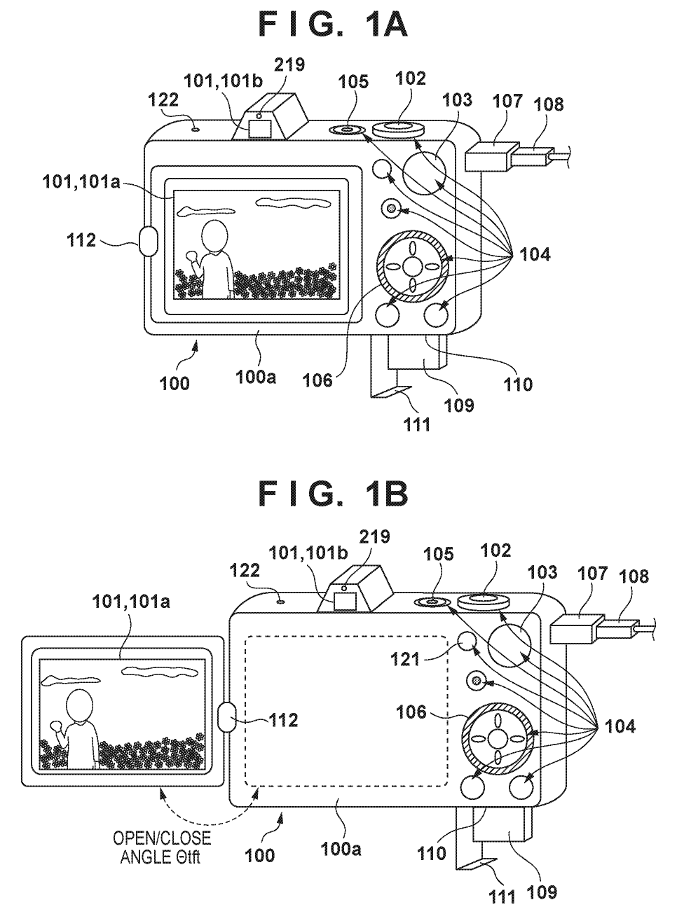

The functions and external view of a digital camera 100 will be described with reference to FIG. 1A to FIG. 4. FIG. 1A and FIG. 1B are diagrams of the digital camera 100 as viewed from the back. In FIG. 1A, the digital camera 100 is in a state where a display surface of a vari-angle monitor 101a is facing a photographer. In FIG. 1B, the digital camera 100 is in a state where the display surface of the vari-angle monitor 101a is facing a photographer. FIG. 1C is a diagram of the digital camera 100 as viewed from the front. In FIG. 1C, the digital camera 100 is in a state where the display surface of the vari-angle monitor 101a is facing a subject.

A display unit 101 includes, for example, a liquid crystal display panel (LCD) that displays images and various types of information. The display unit 101 includes a vari-angle monitor 101a that is a display unit arranged outside a viewfinder, and an electronic viewfinder (EVF 101b) that is a display unit inside the viewfinder.

The vari-angle monitor 101a is a monitor including, for example, an organic EL or liquid crystal panel, which is provided on a back surface of a camera body 100a (the opposite side of a shooting lens 203). The vari-angle monitor 101a is supported by the camera body 100a via a support unit 112 in such a manner that its positional relationship with the camera body 100a is changeable. A user, who is a photographer, can freely change/rotate the direction/angle of the display surface of the vari-angle monitor 101a relative to the camera body 100a. As will be described later, the positions of the vari-angle monitor 101a include a closed position at which it is stowed on the back surface of the camera body 100a, and an open position at which it is not stowed thereon. Also, the open position includes a state where the display surface is facing a photographer, and a state where the display surface is facing a subject. In a case where the vari-angle monitor 101a is at the open position, the display surface of the vari-angle monitor 101a is located at a side of the camera body 100a.

The EVF 101b can be used by the user to visually confirm an image capturing screen via an eye-proximity unit of a look-through eye-proximity viewfinder.

A shutter button 102 is an operation unit for issuing a shooting instruction. A mode switching button 103 is an operation unit for switching among various types of modes. Operation units 104 are operation units that include such operation members as various types of switches, buttons, and a touch panel that accept various types of operations from the user. A power source switch 105 is an operation unit that switches between ON and OFF of a power source. A controller wheel 106 is a rotatable electronic dial included in the operation units 104. A connector 107 is an interface that connects a connection cable 108 and the digital camera 100. A storage medium 109 is a storage medium like a memory card or a hard disk. A storage medium slot 110 is a slot for stowing the storage medium 109. When stowed in the storage medium slot 110, the storage medium 109 is capable of communicating with the digital camera 100. A lid 111 is a lid for the storage medium slot 110. FIGS. 1A and 1B show a state where the lid 111 has been opened, and a part of the storage medium 109 has been extracted and exposed from the storage medium slot 110.

A light emitting unit 120 is composed of a light-emitting diode (LED) and the like. Using a predetermined pattern of emission/non-emission of light, the light emitting unit 120 notifies a subject that is present at the front side of the camera body 100a of an operating state of the digital camera 100 (e.g., counting down of a self-timer, a start of shooting, and so forth). The light emitting unit 120 is arranged on the front (the subject side or the image capturing surface side) of the camera body 100a so that it can be visually confirmed from the subject side.

A moving image recording button 121 is used to issue an instruction for starting/stopping the shooting (recording) of moving images. A speaker 122 notifies a subject of an operating state of the digital camera 100 (e.g., counting down of the self-timer, a start of shooting, and so forth) by producing a sound of a buzzer or the like.

The vari-angle monitor 101a can be changed to the states shown in FIGS. 1A to 1C, for example.

FIG. 1A shows a state where the vari-angle monitor 101a is stowed in such a manner that a back surface thereof (the opposite side of the display surface) opposes the back surface of the camera body 100a (the closed position). In this state, the photographer can visually confirm the display surface of the vari-angle monitor 101a on the back surface of the camera body 100a. The position of the vari-angle monitor 101a in this state is called an "inverted closed position".

FIG. 1B shows a state where, while the vari-angle monitor 101a is in a state where it is not stowed on the back surface of the camera body 100a (the open position), the display surface of the vari-angle monitor 101a has been turned so as to face the back side of the camera body 100a (the photographer side). In this state, the photographer can visually confirm the display surface of the vari-angle monitor 101a from the back side of the camera body 100a. The position of the vari-angle monitor 101a in this state is called a "non-inverted open position".

FIG. 1C shows a state where, while the vari-angle monitor 101a is in a state where it is not stowed on the back surface of the camera body 100a (the open position), the display surface of the vari-angle monitor 101a has been turned so as to face the forward direction (the subject side) of the camera body 100a. In this state, the photographer cannot visually confirm the display surface of the vari-angle monitor 101a from the back side of the camera body 100a. The position of the vari-angle monitor 101a in this state is called an "inverted open position".

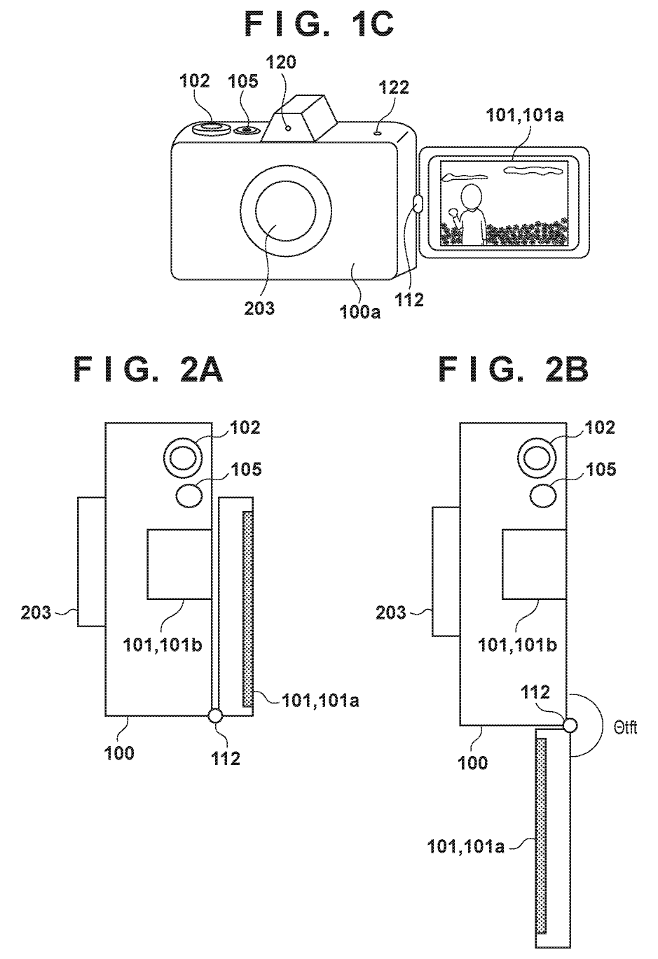

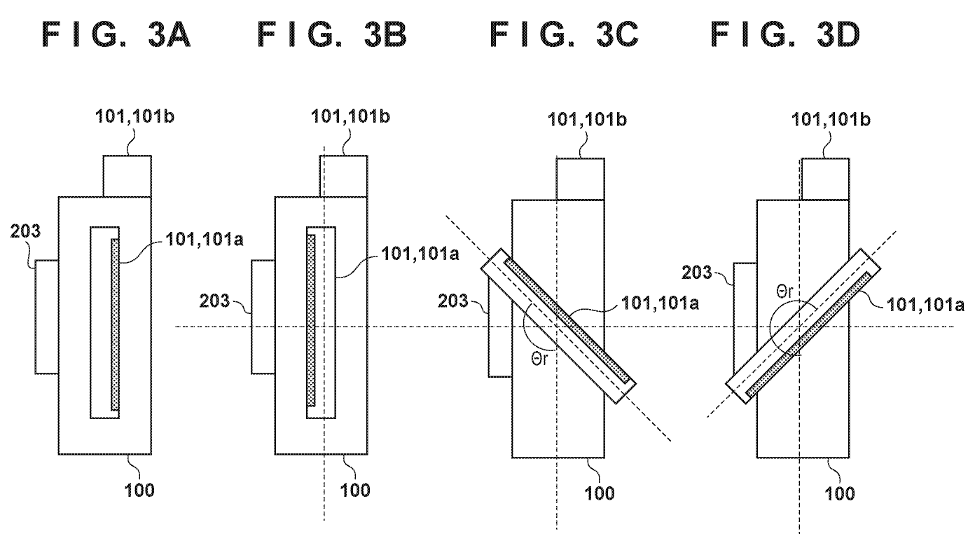

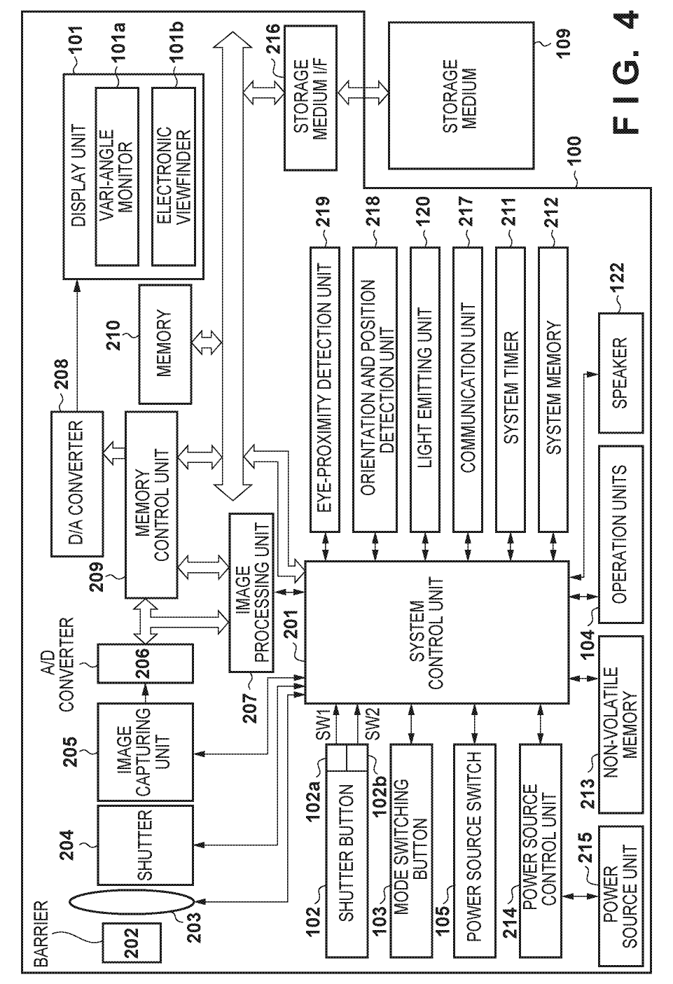

An orientation and position detection unit 218 (FIG. 4) is a sensor that detects the orientation and position (rotational angle and position) of the vari-angle monitor 101a; for example, magnetic sensors and the like are used thereas. At least the states of FIGS. 1A to 1C can be detected by providing the orientation and position detection unit 218 at a plurality of areas. Note that regarding the orientation (position) of the vari-angle monitor 101a, not only the three states of FIGS. 1A to 1C, but also intermediate states until the states of FIGS. 1A to 1C are reached exist, and it is assumed that these intermediate states are also handled as the same state as one of the states of FIGS. 1A to 1C. Typical states among the "intermediate states" will be described with reference to FIGS. 2A and 2B and FIGS. 3A to 3D.

FIG. 2A is a top view of FIG. 1A.

FIG. 2B is a top view of FIG. 1C, in which the vari-angle monitor 101a is opened by Θtft degrees (here, 180 degrees). In a case where Θtft is larger than 0 and smaller than 180, the vari-angle monitor 101a corresponds to the aforementioned "intermediate state".

FIG. 3A is a side view of FIG. 1B.

FIG. 3B is a side view of FIG. 1C.

FIG. 3C and FIG. 3D are side views of the vari-angle monitor 101a of FIG. 1B in a state where it has been rotated by Θr degrees relative to the camera body 100a. The value of Θr differs between the state of FIG. 3C and the state of FIG. 3D. Both of these states correspond to the aforementioned "intermediate state".

The rotational angle Θr is a rotational angle (tilt angle) of the display surface of the vari-angle monitor 101a in a tilt direction relative to the camera body 100a. In FIG. 3C and FIG. 3D, Θr is shown as an angle which acts as a reference (0 degrees) when the display surface of the vari-angle monitor 101a is facing the forward direction of the camera body 100a, and which assumes a clockwise direction as viewed from the left side of the camera body 100a as a positive direction. Note that a reference position of Θr (a position corresponding to 0 degrees) is not limited in particular.

FIG. 4 is a block diagram showing an internal configuration of the digital camera 100. The shooting lens 203 is a lens assembly including a zoom lens and a focus lens. A shutter 204 has a diaphragm function. An image capturing unit 205 is an image sensor composed of, for example, a CCD or a CMOS that converts an optical image of a subject into electrical signals. An A/D converter 206 converts analog signals into digital signals. The A/D converter 206 is used to convert analog signals output from the image capturing unit 205 into digital signals. A barrier 202 covers an image capturing system of the digital camera 100, including the shooting lens 203, thereby preventing the image capturing system, including the shooting lens 203, the shutter 204, and the image capturing unit 205, from being stained or damaged.

An image processing unit 207 executes predetermined pixel interpolation, resizing processing (e.g., reduction processing), color conversion processing, and the like with respect to data from the A/D converter 206, or data from a memory control unit 209. Furthermore, the image processing unit 207 executes predetermined computation processing with use of captured image data. A system control unit 201 performs exposure control and range-finding control based on the computation result obtained from the image processing unit 207. As a result, autofocus (AF) processing, automatic exposure (AE) processing, and preliminary flash emission (EF) processing of the through-the-lens (TTL) method are executed. The image processing unit 207 further executes predetermined computation processing with use of captured image data, and also executes auto white balance (AWB) processing of the TTL method based on the obtained computation result. Image data processed by the image processing unit 207 is written into a memory 210 via a memory control unit 209.

The memory 210 stores image data that has been obtained by the image capturing unit 205 and converted into digital data by the A/D converter 206, and image data to be displayed on the display unit 101. The memory 210 has a storage capacity sufficient to store a predetermined number of still images, and moving images and audio of a predetermined duration.

In addition, the memory 210 also functions as a memory for image display (video memory). A D/A converter 208 converts data for image display stored in the memory 210 into analog signals, and supplies the analog signals to the display unit 101. In this way, image data for display that has been written into the memory 210 is displayed by the display unit 101 via the D/A converter 208. The display unit 101 performs display corresponding to analog signals from the D/A converter 208 on a display device, such as an LCD. The digital signals that have undergone A/D conversion in the A/D converter 206 and have been accumulated in the memory 210 are converted into analog signals by the D/A converter 208, and then sequentially transferred to and displayed on the display unit 101; in this way, live-view images can be displayed. Furthermore, an eye-proximity detection unit 219 is arranged in the vicinity of the EVF 101b. By detecting an eye-proximity state with use of the eye-proximity detection unit 219, the system control unit 201 can switch a display destination of live-view images between the vari-angle monitor 101a and the EVF 101b.

A non-volatile memory 213 is an electrically erasable and recordable memory; for example, an EEPROM or the like is used thereas. Constants, programs, and the like for the operations of the system control unit 201 are stored in the non-volatile memory 213. The programs mentioned here denote programs for executing various types of flowcharts that will be described later in the present embodiment.

The system control unit 201 controls the entirety of the digital camera 100. The system control unit 201 realizes later-described processing of the present embodiment by executing programs stored in the non-volatile memory 213 mentioned above. A system memory 212 is a memory composed of a RAM. Constants and variables for the operations of the system control unit 201, programs that have been read from the non-volatile memory 213, and the like are deployed to the system memory 212. Furthermore, the system control unit 201 also performs display control by controlling the memory 210, the D/A converter 208, the display unit 101, and the like.

A system timer 211 is a time measurement unit that measures times used in various types of control, and the time of an internal clock.

The mode switching button 103, a first shutter switch 102a, a second shutter switch 102b, and the operation units 104 are operation units for inputting various types of operating instructions to the system control unit 201 in accordance with a user operation.

The mode switching button 103 switches an operating mode of the system control unit 201 to one of a still image shooting mode, a moving image recording mode, a reproduction mode, and the like. Modes included in the still image shooting mode are an auto mode, an auto scene distinction mode, a manual mode, various types of scene modes in which shooting settings are configured on a scene-by-scene basis, a program AE mode, a custom mode, and so forth. The mode switching button 103 is used to switch directly to one of these modes. Alternatively, after switching to a shooting mode selection screen with use of the mode switching button 103, mode switching may be performed by selecting, with use of another operation member, one of options which are displayed on the shooting mode selection screen and which correspond to the respective shooting modes. Similarly, the moving image recording mode may include a plurality of modes.

The first shutter switch 102a is turned ON and generates a first shutter switch signal SW1 halfway through an operation performed on the shutter button 102 provided on the digital camera 100, that is to say, when the shutter button 102 is half-pressed (a shooting preparation instruction). In response to the first shutter switch signal SW1, the system control unit 201 starts shooting preparation processing, such as AF processing, AE processing, AWB processing, and EF processing.

The second shutter switch 102b is turned ON and generates a second shutter switch signal SW2 upon completion of the operation performed on the shutter button 102, that is to say, upon so-called full-pressing of the shutter button 102 (a shooting instruction). In response to the second shutter switch signal SW2, the system control unit 201 starts a sequence of shooting processing, from readout of signals from the image capturing unit 205 to writing of image data into the storage medium 109.

The respective operation members of the operation units 104 are assigned functions as appropriate on a scene-by-scene basis and act as various types of function buttons as a result of, for example, selecting and operating a variety of function icons displayed on the display unit 101. Examples of the function buttons include an end button, a return button, a next image button, a jump button, a filter button, an attribute change button, and so on. For example, a menu screen on which various types of settings can be configured is displayed on the display unit 101 when a menu button has been pressed. A user can configure various types of settings intuitively using the menu screen displayed on the display unit 101, together with four direction buttons including up, down, left, and right buttons, and a set button.

The controller wheel 106 is an operation member which is included in the operation units 104 and on which a rotational operation can be performed, and is used when, for example, issuing an instruction about an item to be selected, together with the direction buttons. When a rotational operation has been performed on the controller wheel 106, an electrical pulse signal is generated in accordance with the amount of operation, and the system control unit 201 controls each unit of the digital camera 100 based on this pulse signal. For example, the angle of the rotational operation performed on the controller wheel 106, and how many times it has been rotated, can be determined with use of this pulse signal. Note that the controller wheel 106 may be any operation member as long as a rotational operation performed thereon can be detected. For example, it may be a dial operation member in which the controller wheel 106 itself rotates to generate a pulse signal in accordance with a rotational operation performed by the user. Further, it may be an operation member composed of a touch sensor, in which the controller wheel 106 itself does not rotate but a rotation operation or the like of the user's finger on the controller wheel 106 is detected (a so-called touch wheel).

Note that the digital camera 100 includes, as one of the operation units 104, a touch panel capable of detecting contact on the display surface of the vari-angle monitor 101a. The touch panel and the vari-angle monitor 101a can be configured integrally. For example, the touch panel is configured so that a light transmittance thereof does not interfere with display of the vari-angle monitor 101a, and the touch panel is attached to the top layer of the display surface of the vari-angle monitor 101a. Then, input coordinates of the touch panel are associated with display coordinates of the vari-angle monitor 101a. This makes it possible to configure a GUI that allows the user to operate, as if directly, a screen displayed on the vari-angle monitor 101a. The system control unit 201 detects the user's touch on the touch panel, and executes processing corresponding to a touch position. Any of a variety of types of touch panels, such as a resistive film type, an electrostatic capacitance type, a surface elastic wave type, an infrared type, an electromagnetic induction type, an image recognition type, and an optical sensor type, may be used as the touch panel.

The system control unit 201 can detect the following operations on the touch panel. Touching the touch panel with a finger or a stylus (hereinafter, a touch-down). A state where the touch panel is touched by a finger or a stylus (hereinafter, a touch-on). Moving a finger or a stylus while the finger or the stylus is touching the touch panel (hereinafter, a slide). Releasing, from the touch panel, a finger or a stylus that was touching the touch panel (hereinafter, a touch-up). A state where nothing is touching the touch panel (hereinafter, a touch-off). The system control unit 201 is notified of these operations and positional coordinates on the touch panel where a finger or a stylus is touching. The system control unit 201 determines what kind of operation has been performed on the touch panel based on the information it has been notified of.

A power source control unit 214 is composed of a battery detection circuit, a DC-DC converter, switch circuits for switching the blocks to which power is to be supplied, and so on, and detects whether a battery is loaded, a battery type, and a remaining battery level. Also, the power source control unit 214 controls the DC-DC converter based on the detection results and instructions from the system control unit 201, and supplies a necessary voltage for a necessary time period to various units, including the storage medium 109.

A power source unit 215 is a primary battery such as an alkaline battery and a lithium battery, a secondary battery such as a NiCd battery, a NiMH battery and a lithium-ion battery, or an AC adapter, for example. A storage medium I/F 216 is an interface with the storage medium 109, which is a memory card, a hard disk, or the like. The storage medium 109 is a storage medium, such as a memory card, for storing shot images, and is composed of a semiconductor memory, a magnetic disk, or the like.

A communication unit 217 connects to an external device via a wireless antenna or a wired cable in such a manner that they can communicate with each other, and transmits/receives videos and sounds. The communication unit 217 can also connect to a wireless local area network (LAN) and the Internet. The communication unit 217 can transmit image data captured by the image capturing unit 205 (including live-view images) and image files stored in the storage medium 109 to the external device, and can also receive image data and other various types of information from the external device.

The orientation and position detection unit 218 detects an orientation of the digital camera 100 relative to the gravitational direction. Whether an image captured by the image capturing unit 205 was shot with the digital camera 100 held horizontally, or shot with the digital camera 100 held vertically, can be distinguished in accordance with the orientation detected by the orientation and position detection unit 218. Furthermore, whether the digital camera 100 has moved upward or downward can also be detected. The system control unit 201 can add information related to the orientation detected by the orientation and position detection unit 218 to image data captured by the image capturing unit 205, and rotate and store the image data. An acceleration sensor, a gyroscope, or the like can be used as the orientation and position detection unit, which can detect movements of the digital camera 100 (e.g., panning, tilting, lifting, and a stationary state).

Furthermore, as stated earlier, the orientation and position detection unit 218 (FIG. 4) also includes a sensor (e.g., a magnetic sensor) that detects an orientation and a position (a rotational angle and position) of the vari-angle monitor 101a.

The eye-proximity detection unit 219 detects proximity (eye proximity) and separation (eye separation) of an eye (object) to and from the eye-proximity unit of the viewfinder (proximity detection). The system control unit 201 switches between display (a displaying state) and non-display (a non-displaying state) of the vari-angle monitor 101a and the EVF 101b in accordance with the state detected by the eye-proximity detection unit 219. An infrared proximity sensor or the like can be used as the eye-proximity detection unit 219, which can detect proximity of some sort of object to the eye-proximity unit of the viewfinder that includes the EVF 101b built therein. In a case where an object has approached, infrared light projected from a light projection unit (not shown) of the eye-proximity detection unit 219 is reflected and received by a light receiving unit (not shown) of the infrared proximity sensor. It is also possible to distinguish at what distance from the eye-proximity unit the approaching object is situated (an eye-proximity distance) based on the amount of the received infrared light. In this way, the eye-proximity detection unit 219 performs eye-proximity detection for detecting the proximity distance of the object to the eye-proximity unit.

It is assumed that eye proximity is detected when an object that approaches to within a predetermined distance of the eye-proximity unit of the viewfinder is detected in a non-eye-proximity state (non-proximity state). It is assumed that eye separation is detected when the object being detected in proximity moves away by a predetermined distance or more while in an eye-proximity state (proximity state). A threshold for detection of eye proximity and a threshold for detection of eye separation may be different from each other due to, for example, provision of hysteresis and the like. Furthermore, it is assumed that a detection of eye proximity is followed by the eye-proximity state until eye separation is detected. It is assumed that a detection of eye separation is followed by the non-eye-proximity state until eye proximity is detected. Note that the infrared proximity sensor is an example, and another sensor may be adopted as the eye-proximity detection unit 219 as long as it can detect proximity of an eye or an object that can be regarded as eye proximity.

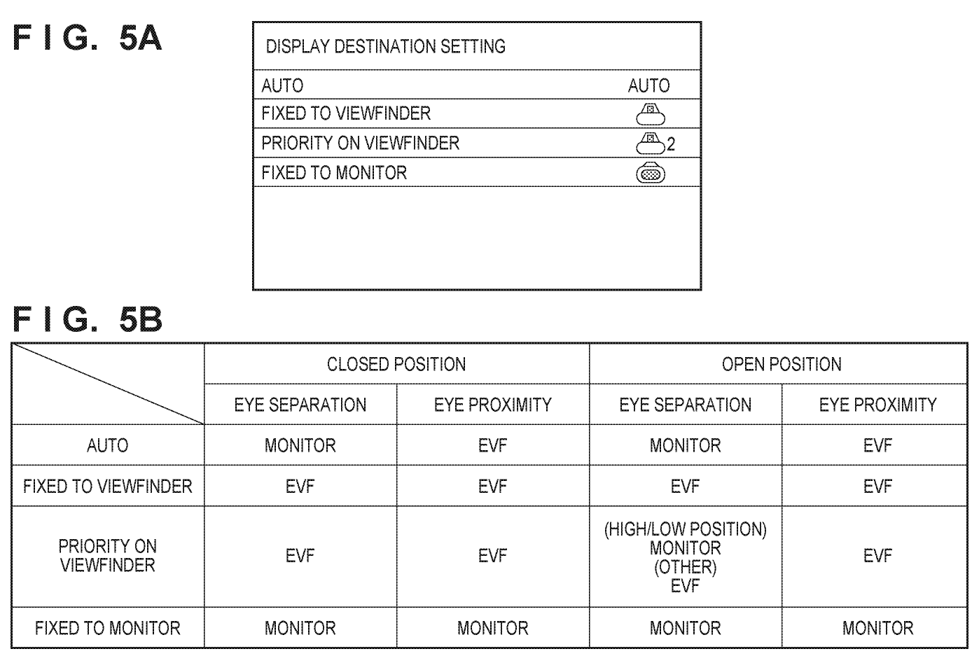

FIG. 5A is a diagram showing an example of a display destination setting screen displayed by the digital camera 100. In response to a user instruction, the system control unit 201 displays the display destination setting screen on, for example, the vari-angle monitor 101a or the EVF 101b. On the display destination setting screen, a user can configure a setting related to selection of a display destination of images (e.g., live-view images) from the digital camera 100 (a display destination setting).

In the example of FIG. 5A, the display destination setting screen includes "auto" (a third mode), "fixed to viewfinder" (a second mode), "priority on viewfinder" (a first mode), and "fixed to monitor" (a fourth mode) as options of the display destination setting (a selection mode of the display destination). The system control unit 201 sets the display destination setting (selection mode) to the display destination setting that has been selected on the display destination setting screen. In accordance with a selection criterion corresponding to the selected display destination setting, the system control unit 201 selects one of the vari-angle monitor 101a and the EVF 101b as a display destination.

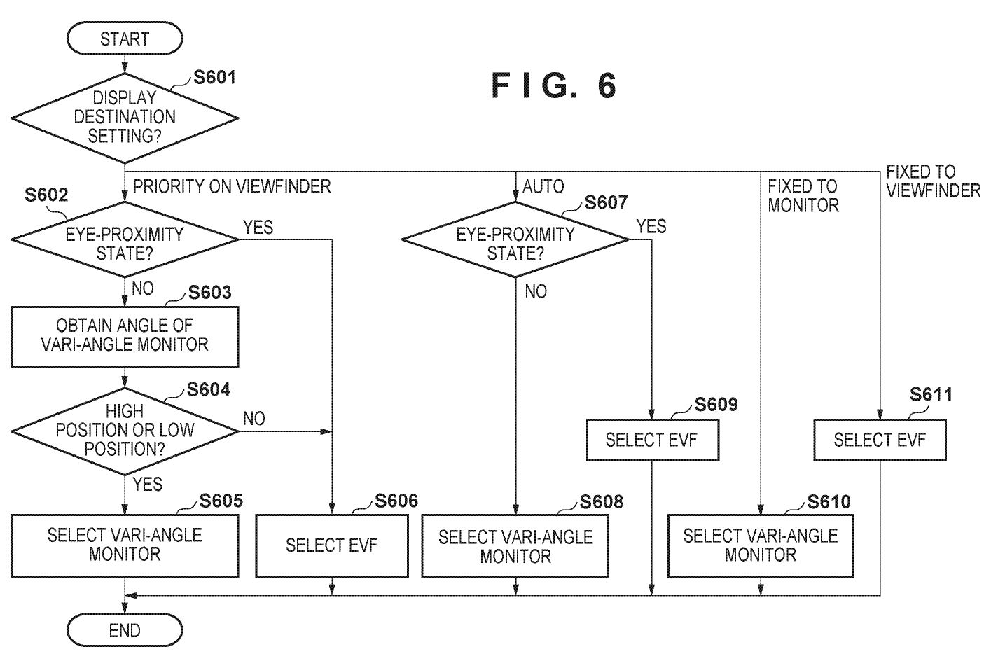

FIG. 5B is a diagram showing display destination selection criteria corresponding to different display destination settings. In FIG. 5B, "monitor" indicates the vari-angle monitor 101a, and "EVF" indicates the EVF 101b. For example, in a case where the display destination setting is the auto setting, the system control unit 201 selects the vari-angle monitor 101a in an eye-separation state and selects the EVF 101b in an eye-proximity state, regardless of the position of the vari-angle monitor 101a. The details will be described later with reference to FIG. 6.

FIG. 6 is a flowchart of display destination selection processing executed by the digital camera 100. Processing of each step of the present flowchart is realized by the system control unit 201 executing a program stored in the non-volatile memory 213, unless specifically stated otherwise. In the description of the present flowchart, it is assumed that the digital camera 100 is in a shooting standby state (a state where live-view images are displayed), and images displayed on the selected display destination are live-view images. While the digital camera 100 is in the shooting standby state, the system control unit 201 repeatedly executes the display destination selection processing of the present flowchart.

Note that in the present embodiment, the state of the digital camera 100 is not limited to the shooting standby state. For example, the display destination selection processing of the present embodiment may be applied to a case where the digital camera 100 is in a state where it is reproducing shot images. In this case, images displayed on the selected display destination are shot images that have been selected as reproduction targets.

In step S601, the system control unit 201 performs conditional branching in accordance with a display destination setting. Processing proceeds to steps S602, S607, S610, and S611 in cases where the display destination setting is "priority on viewfinder", "auto", "fixed to monitor", and "fixed to viewfinder", respectively.

In step S602, based on a state detected by the eye-proximity detection unit 219, the system control unit 201 determines whether an object is in proximity to the EVF 101b (whether the detected state is the eye-proximity state or the eye-separation state). In the case of the eye-proximity state, processing proceeds to step S606; otherwise, processing proceeds to step S603.

In step S603, the system control unit 201 obtains an open/close angle Θtft and a rotational angle Θr of the vari-angle monitor 101a with use of the orientation and position detection unit 218.

In step S604, based on the open/close angle Θtft and the rotational angle Θr, the system control unit 201 determines whether the vari-angle monitor 101a is at a "high position or low position". For example, in a case where the open/close angle Θtft and the rotational angle Θr satisfy the following high position condition, the system control unit 201 determines that the vari-angle monitor 101a is at the high position. Meanwhile, in a case where the open/close angle Θtft and the rotational angle Θr satisfy the following low position condition, the system control unit 201 determines that the vari-angle monitor 101a is at the low position.

High position condition: 135 degrees ≤ Θtft, and 220 degrees ≤ Θr ≤ 270 degrees

Low position condition: 135 degrees ≤ Θtft, and 90 degrees ≤ Θr ≤ 140 degrees

Therefore, in a case where the open/close angle Θtft and the rotational angle Θr satisfy the following high position condition or low position condition, the system control unit 201 determines that the vari-angle monitor 101a is at the "high position or low position". In a case where the vari-angle monitor 101a is at the "high position or low position", processing proceeds to step S605; otherwise, processing proceeds to step S606.

Although the angle ranges of the aforementioned high position condition and low position condition are examples of angle ranges that can be adopted in a camera including a monitor like the vari-angle monitor 101a, the present embodiment is not limited to specific angle ranges.

In step S605, the system control unit 201 selects the vari-angle monitor 101a as a display destination. In response to selection of the display destination, the system control unit 201 performs control to display images on the selected display destination (here, the vari-angle monitor 101a).

In step S606, the system control unit 201 selects the EVF 101b as a display destination. It performs control to display images on the selected display destination (here, the EVF 101b).

Therefore, when the display destination setting is priority on viewfinder, although the EVF 101b is preferentially selected as a display destination, the vari-angle monitor 101a is selected as a display destination in the case of the "eye-separation state" and the "high position or low position".

In step S607, based on a state detected by the eye-proximity detection unit 219, the system control unit 201 determines whether an object is in proximity to the EVF 101b (whether the detected state is the eye-proximity state or the eye-separation state), similarly to step S602. In the case of the eye-proximity state, processing proceeds to step S609; otherwise, processing proceeds to step S608.

In step S608, the system control unit 201 selects the vari-angle monitor 101a as a display destination.

In step S609, the system control unit 201 selects the EVF 101b as a display destination.

Therefore, when the display destination setting is auto, a display destination is switched in accordance with whether the detected state is the eye-proximity state or the eye-separation state, regardless of the position of the vari-angle monitor 101a.

In step S610, the system control unit 201 selects the vari-angle monitor 101a as a display destination.

Therefore, when the display destination setting is fixed to monitor, the vari-angle monitor 101a is selected as a display destination, regardless of the position of the vari-angle monitor 101a, and also regardless of the state detected by the eye-proximity detection unit 219.

In step S611, the system control unit 201 selects the EVF 101b as a display destination.

Therefore, when the display destination setting is fixed to viewfinder, the EVF 101b is selected as a display destination, regardless of the position of the vari-angle monitor 101a, and also regardless of the state detected by the eye-proximity detection unit 219.

Note that under the "priority on viewfinder" setting in the example of FIG. 6, the vari-angle monitor 101a is selected as a display destination in a case where the EVF 101b is in the eye-separation state and the vari-angle monitor 101a is at the "high position or low position". However, the position of the vari-angle monitor 101a according to this selection criterion (selection condition) (its positional relationship with the camera body 100a) is not limited to the "high position or low position". Therefore, under the "priority on viewfinder" setting of the present embodiment, the system control unit 201 can select the vari-angle monitor 101a as a display destination in a case where the following selection condition is satisfied: the EVF 101b is in the eye-separation state, and the positional relationship of the vari-angle monitor 101a with the camera body 100a satisfies a predetermined positional condition.

A state where the vari-angle monitor 101a is at the "high position or low position" is an example of the predetermined positional condition. According to the description of step S604, the high position condition and the low position condition include conditions related to both of the open/close angle Θtft and the rotational angle Θr. Therefore, the predetermined positional condition includes conditions related to both of the open/close angle Θtft and the rotational angle Θr. However, in a case where the vari-angle monitor 101a is configured to be rotatable in the tilt direction behind the camera body 100a without being deployed to the side of the camera body 100a as in FIG. 1B, the predetermined positional condition need not include the condition related to the open/close angle Θtft. In this case, the predetermined positional condition may include the condition related to the rotational angle Θr, and the condition related to the rotational angle Θr may be a condition where the tilt angle of the display surface of the vari-angle monitor 101a relative to the camera body 100a is within a predetermined angle range. In this case, the predetermined positional condition is satisfied in a case where the tilt angle of the display surface of the vari-angle monitor 101a relative to the camera body 100a is within the predetermined angle range.

The predetermined angle range may be, for example, a range that does not include a range of D₁ degrees (D₁ < 180) to D₂ degrees (D₂ > 180). Also, the predetermined angle range may be a range that includes neither a range of 0 degrees to D₃ degrees (D₃ < 90) nor a range of D₄ degrees (D₄ > 270) to 360 degrees. D₁ may be equal to or smaller than 140, and D₂ may be equal to or larger than 220. Furthermore, D₁ may be larger than 90, and D₂ may be smaller than 270. In a case where D₁ = 140, D₂ = 220, D₃ = 90, and D₄ = 270, the predetermined angle range is a range that includes a range of 220 degrees or more to 270 degrees or less, and includes a range of 90 degrees or more to 140 degrees or less. That is to say, in this case, the predetermined angle range is the same range as the range of the rotational angle Θr of the high position condition and the low position condition described in step S604.

Furthermore, the predetermined positional condition may include the condition related to the open/close angle Θtft without including the condition related to the rotational angle Θr.

As described above, according to the first embodiment, the digital camera 100 includes the vari-angle monitor 101a, which is attached to the camera body 100a in such a manner that its positional relationship with the camera body 100a is changeable, and the EVF 101b. The digital camera 100 can operate under the display destination setting of "priority on viewfinder". In this case, the digital camera 100 determines whether an object is in proximity to the EVF 101b, and determines whether the positional relationship of the vari-angle monitor 101a satisfies the predetermined positional condition (e.g., "high position or low position"). In a case where a condition (a first selection condition) is satisfied where an object is not in proximity to the EVF 101b and the positional relationship of the vari-angle monitor 101a satisfies the predetermined positional condition, the digital camera 100 selects the vari-angle monitor 101a as a display destination. In a case where the first selection condition is not satisfied, the digital camera 100 selects the EVF 101b as a display destination. The digital camera 100 performs control to display images on the selected display destination.

In a case where the EVF 101b is in the eye-separation state and a user has changed the positional relationship of the vari-angle monitor 101a so that the positional relationship of the vari-angle monitor 101a satisfies the predetermined positional condition, it is considered that there is a possibility that the user has difficulty looking through the EVF 101b for some reason. Under the "priority on viewfinder" setting of the present embodiment, although the EVF 101b is preferentially selected, the vari-angle monitor 101a is selected in a case where it is considered that there is a possibility that the user has difficulty looking through the EVF 101b. Therefore, according to the present embodiment, a display destination can be selected with an intention to further improve user experience.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-003074, filed January 8, 2025, which is hereby incorporated by reference herein in its entirety.

What is claimed is:

1. An image capturing apparatus, comprising:
a first display unit attached to a body of the image capturing apparatus in such a manner that a positional relationship of the first display unit with the body is changeable;
a second display unit; and
at least one processor and/or at least one circuit configured to:
determine whether an object is in proximity to the second display unit;
determine whether the positional relationship satisfies a predetermined positional condition;
select one of the first display unit and the second display unit as a display destination, including selecting the first display unit in a case where a first selection condition is satisfied, and selecting the second display unit in a case where the first selection condition is not satisfied, wherein the first selection condition is a condition that the object is not in proximity to the second display unit and furthermore the positional relationship satisfies the predetermined positional condition; and
perform control to display an image on the selected display destination.

2. The image capturing apparatus according to claim 1, wherein
the predetermined positional condition is satisfied in a case where a tilt angle of a display surface of the first display unit relative to the body is within a predetermined angle range.

3. The image capturing apparatus according to claim 2, wherein
the predetermined positional condition is satisfied in a case where the tilt angle of the display surface is within the predetermined angle range and furthermore the display surface is located at a lateral side of the body.

4. The image capturing apparatus according to claim 2, wherein
letting the tilt angle of the display surface be 0 degrees when the display surface faces a forward direction of the body and letting a positive direction be a clockwise direction as viewed from a left side of the body, the predetermined angle range does not include a range of D₁ degrees (D₁ < 180) to D₂ degrees (D₂ > 180).

5. The image capturing apparatus according to claim 4, wherein
D₁ is less than or equal to 140, and D₂ is greater than or equal to 220.

6. The image capturing apparatus according to claim 5, wherein
D₁ is greater than 90, and D₂ is less than 270.

7. The image capturing apparatus according to claim 1, wherein the at least one processor and/or the at least one circuit are further configured to
set a selection mode of the display destination, wherein
when the selection mode is a first mode, the first display unit is selected in a case where the first selection condition is satisfied, and the second display unit is selected in a case where the first selection condition is not satisfied, and
when the selection mode is a second mode, the second display unit is selected regardless of whether the object is in proximity to the second display unit and also regardless of whether the positional relationship satisfies the predetermined positional condition.

8. The image capturing apparatus according to claim 7, wherein the at least one processor and/or the at least one circuit are further configured to
perform control to display, on the first display unit or the second display unit, a setting screen including a plurality of modes as options in response to a user instruction, the plurality of modes including the first mode and the second mode, and
the selection mode is set to a mode selected on the setting screen.

9. The image capturing apparatus according to claim 1, wherein
the second display unit is arranged inside a viewfinder of the image capturing apparatus.

10. A control method executed by an image capturing apparatus, wherein
the image capturing apparatus comprises:
a first display unit attached to a body of the image capturing apparatus in such a manner that a positional relationship of the first display unit with the body is changeable; and
a second display unit, and
the control method comprises:
determining whether an object is in proximity to the second display unit;
determining whether the positional relationship satisfies a predetermined positional condition;
selecting one of the first display unit and the second display unit as a display destination, including selecting the first display unit in a case where a first selection condition is satisfied, and selecting the second display unit in a case where the first selection condition is not satisfied, wherein the first selection condition is a condition that the object is not in proximity to the second display unit and furthermore the positional relationship satisfies the predetermined positional condition; and
performing control to display an image on the selected display destination.

11. A non-transitory computer-readable storage medium which stores a program for causing a computer of an image capturing apparatus to execute a control method, wherein
the image capturing apparatus comprises:
a first display unit attached to a body of the image capturing apparatus in such a manner that a positional relationship of the first display unit with the body is changeable; and
a second display unit, and
the control method comprises:
determining whether an object is in proximity to the second display unit;
determining whether the positional relationship satisfies a predetermined positional condition;
selecting one of the first display unit and the second display unit as a display destination, including selecting the first display unit in a case where a first selection condition is satisfied, and selecting the second display unit in a case where the first selection condition is not satisfied, wherein the first selection condition is a condition that the object is not in proximity to the second display unit and furthermore the positional relationship satisfies the predetermined positional condition; and
performing control to display an image on the selected display destination.
